(19) United States
(12) Patent Application Publication
(10) Pub. No.: US 2017/0308646 A1
(43) Pub. Date: Oct. 26, 2017

(54) IMAGE PROCESSING APPARATUS, IMAGE PROCESSING METHOD, AND PRESCRIPTION MANAGEMENT SYSTEM

(71) Applicant: Taku YAMAWAKI, Tokyo (JP)

(72) Inventor: Taku YAMAWAKI, Tokyo (JP)

(73) Assignee: Ricoh Company, Ltd., Tokyo (JP)

(21) Appl. No.: 15/485,523

(22) Filed: Apr. 12, 2017

(30) Foreign Application Priority Data
Apr. 21, 2016 (JP) 2016-085546

(51) Int. Cl. G06F 19/00; G06F 3/12; H04N 1/00

(52) U.S. Cl. CPC G06F 19/321; G06F 19/3456; G06F 3/1243; H04N 1/00405; H04N 1/00015; G06F 3/1203; G06F 19/324; G06F 3/1284; H04N 2201/0081; H04N 2201/0082

(57) ABSTRACT

An image processing apparatus includes processing circuitry configured to read, from a prescription, a prescription image including a first image including first prescription information that is visible and a second image including second prescription information that is invisible; analyze the second image to acquire the second prescription information; and display, on a display device, the first prescription information and the second prescription information in a comparable format.

### CROSS-REFERENCE TO RELATED APPLICATION

The present application claims priority under 35 U.S.C. §119 to Japanese Patent Application No. 2016-085546, filed on Apr. 21, 2016, the contents of which are incorporated herein by reference in their entirety.

### BACKGROUND OF THE INVENTION

### 1. Field of the Invention

The present invention relates to an image processing apparatus, an image processing method, and a prescription management system.

### 2. Description of the Related Art

A dispensing pharmacy prescribes medicine to a patient, by following a prescription issued by a medical institution. Generally, in a prescription, prescription information is described, such as the name of the medial institution that has issued the prescription; the insured number, the name, and the birthdate of the patient; and the name and the quantity of the medicine to be prescribed.

Conventionally, this prescription information has been manually input to a terminal of the dispensing pharmacy. This manual inputting operation has been a burden on the staff of the dispensing pharmacy, and has caused erroneous inputs. Therefore, as a method of simplifying the operation of inputting the prescription information, there has been proposed a method of printing a two-dimensional code including the prescription information, on the prescription sheet. According to this method, by analyzing the two-dimensional code with an image processing apparatus, the prescription information can be quickly and accurately input to the terminal of the dispensing pharmacy.

Patent Document 1: Japanese Unexamined Patent Application Publication No. 2004-199481

Non-patent Document 1: JAHIS (Japanese Association of Healthcare Information Systems Industry) Technical document 12-101, External prescription two-dimensional symbol recording condition terms Ver1.1

### SUMMARY OF THE INVENTION

An aspect of the present invention provides an image processing apparatus, an image processing method, and a prescription management system in which one or more of the above-described disadvantages are reduced.

According to one aspect of the present invention, there is provided an image processing apparatus including processing circuitry configured to read, from a prescription, a prescription image including a first image including first prescription information that is visible and a second image including second prescription information that is invisible; analyze the second image to acquire the second prescription information; and display, on a display device, the first prescription information and the second prescription information in a comparable format.

### BRIEF DESCRIPTION OF THE DRAWINGS

Other objects, features and advantages of the present invention will become more apparent from the following detailed description when read in conjunction with the accompanying drawings, in which:

FIG. 1 illustrates a configuration of a prescription management system according to a first embodiment of the present invention;

FIG. 2 illustrates an example of a hardware configuration of a medical institution terminal according to the first embodiment of the present invention;

FIG. 3 illustrates an example of a hardware configuration of an image forming apparatus according to the first embodiment of the present invention;

FIG. 4 illustrates an example of a software group included in the multifunction peripheral according to the first embodiment of the present invention;

FIG. 5 illustrates an example of a prescription image according to the first embodiment of the present invention;

FIG. 6 illustrates an example of a functional configuration of an image processing apparatus according to the first embodiment of the present invention;

FIG. 7 is a sequence diagram of an example of operations by the image processing apparatus according to the first embodiment of the present invention;

FIG. 8 is a flowchart of an example of operations by the image processing apparatus according to the first embodiment of the present invention;

FIG. 9 illustrates an example of the first prescription information and the second prescription information displayed on a display device according to the first embodiment of the present invention;

FIG. 10 illustrates an example of the first prescription information and the second prescription information displayed on a display device according to the first embodiment of the present invention;

FIG. 11 illustrates an example of a prescription image according to a second embodiment of the present invention;

FIG. 12 illustrates an example of a functional configuration of the image processing apparatus according to the second embodiment of the present invention;

FIG. 13 is a flowchart of an example of operations by the image processing apparatus according to the second embodiment of the present invention;

FIG. 14 illustrates an example of the first prescription information and the second prescription information displayed on a display device according to the second embodiment of the present invention;

FIG. 15 illustrates an example of a prescription image according to the second embodiment of the present invention;

FIG. 16 illustrates an example of first prescription information and second prescription information displayed on a display device according to the second embodiment of the present invention;

FIG. 17 illustrates an example of a functional configuration of the image processing apparatus according to a third embodiment of the present invention;

FIG. 18 is a flowchart of an example of operations by the image processing apparatus according to the third embodiment of the present invention; and

FIG. 19 illustrates an example of the first prescription information and the second prescription information displayed on a display device according to the third embodiment of the present invention.

### DETAILED DESCRIPTION OF THE PREFERRED EMBODIMENTS

In recent years, there have been problems in that a malicious patient falsifies the prescription information (for example, the name and the quantity of a medicine) to illegally acquire a medicine. The same problem also applies to the method of the related art of printing a two-dimensional code on the prescription sheet. This is because the method of the related art uses a two-dimensional code whose definition and format are open to the public, such as a Quick Response (QR) code (registered trademark). By using an existing application, a malicious patient can easily generate a two-dimensional code including falsified prescription information, and falsify the prescription.

A problem to be solved by an embodiment of the present invention is to assure the prescription information.

Embodiments of the present invention will be described by referring to the accompanying drawings. In the specification and drawings of the embodiments, the elements having substantially the same functions are denoted by the same reference numerals, and overlapping descriptions are omitted.

### First Embodiment

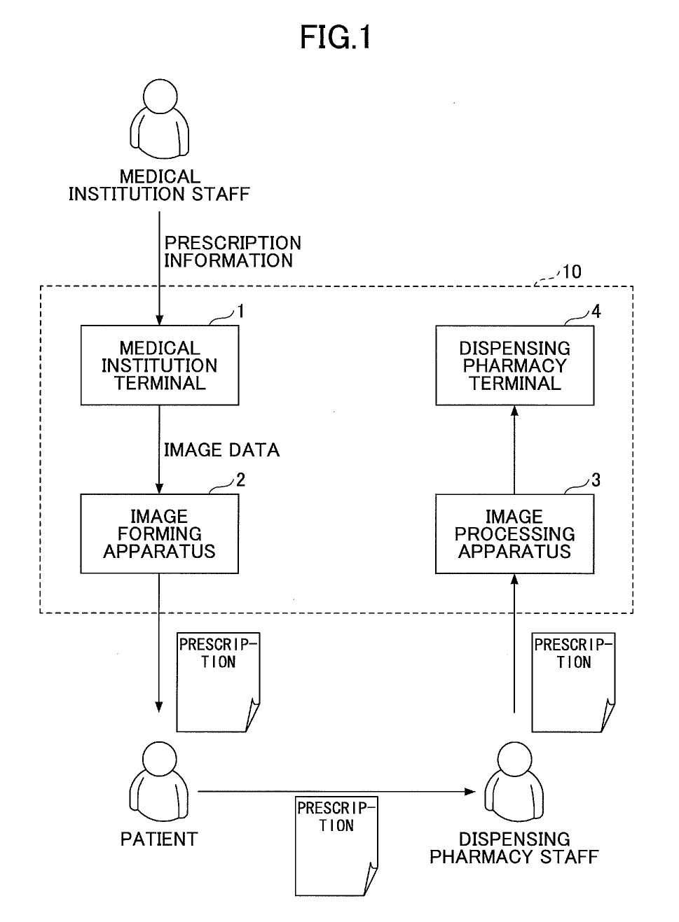

First, a description is given of a first embodiment by referring to FIGS. 1 through 10. A prescription management system 10 according to the present embodiment is a system for managing prescriptions and assuring prescription information. A prescription is a document that is issued by a medial institution with respect to a patient, and that is used for preparing a medicine at a dispensing pharmacy.

A prescription is created by describing prescription information on a predetermined prescription sheet, by character strings and images. Methods of describing prescription information on a prescription sheet include printing and handwriting. In the following, a description is given of an example in which the prescription information is printed on a prescription sheet; however, part of or all of the prescription information may be handwritten on the prescription sheet.

FIG. 1 illustrates a configuration of the prescription management system 10. As illustrated in FIG. 1, the prescription management system 10 includes a medical institution terminal 1, an image forming apparatus 2, an image processing apparatus 3, and a dispensing pharmacy terminal 4.

### <Configuration of Medical Institution Terminal 1—First Embodiment>

The medical institution terminal 1 is a terminal (computer) installed in a medical institution, and is coupled to the image forming apparatus 2. In the example of FIG. 1, one medical institution terminal 1 is coupled to the image forming apparatus 2; however, a plurality of medical institution terminals 1 may be coupled to the image forming apparatus 2.

The medical institution terminal 1 is used by a staff of the medical institution to input prescription information. The prescription information includes the name of the medial institution that has issued the prescription; the insured number, the name, and the birthdate of the patient; and the name and the quantity of the medicine to be prescribed. The medical institution terminal 1 generates image data of the prescription image based on the input prescription information.

The prescription image is an image including the prescription information, and the prescription image corresponds to the front image of the prescription. As the prescription image is printed on the prescription sheet, the prescription is created. Details of the prescription image are described below. The medical institution terminal 1 inputs the image data of the created prescription image, in the image forming apparatus 2.

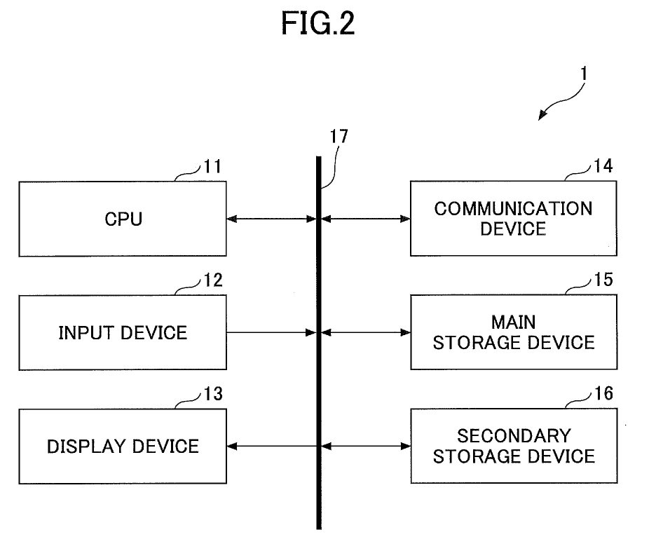

FIG. 2 illustrates an example of a hardware configuration of the medical institution terminal 1.

The medical institution terminal 1 of FIG. 2 includes a Central Processing Unit (CPU) 11, an input device 12, a display device 13, a communication device 14, a main storage device 15, a secondary storage device 16, and a bus 17.

The CPU 11 executes the Operating System (OS) and various kinds of software, and realizes the functions of the medical institution terminal 1. For example, the CPU 11 executes software for generating image data of a prescription image based on the prescription information.

The input device 12 is, for example, a keyboard, a mouse, or a touch panel; however, the input device 12 is not so limited. The staff of the medical institution operates the input device 12 to input prescription information in the medical institution terminal 1.

The display device 13 is, for example, a liquid crystal display, a cathode ray tube display, or a plasma display; however, the display device 13 is not so limited.

The communication device 14 is, for example, a modem, a hub, and a router; however, the communication device 14 is not so limited. The medical institution terminal 1 may send the image data of the prescription image to the image forming apparatus 2 via the communication device 14.

The main storage device 15 is, for example, a Random Access Memory (RAM), a Static Random Access Memory (SRAM), or a Dynamic Random Access Memory (DRAM); however, the main storage device 15 is not so limited.

The secondary storage device 16 is, for example, a Hard Disk Drive (HDD), an optical disk, a flash memory, or a magnetic tape; however, the secondary storage device 16 is not so limited. The secondary storage device 16 stores various kinds of software executed by the CPU 11 and various kinds of data used by the medical institution terminal 1.

The bus 17 couples the CPU 11, the input device 12, the display device 13, the communication device 14, the main storage device 15, and the secondary storage device 16 to each other.

### <Configuration of Image Forming Apparatus 2—First Embodiment>

The image forming apparatus 2 has a printer function, and prints a prescription image on a prescription sheet based on image data input from the medical institution terminal 1. Accordingly, a prescription is created. The prescription created by the image forming apparatus 2 is issued to the patient. The printing method of the image forming apparatus 2 is, for example, an inkjet method or a laser method. The image forming apparatus 2 is a printer or a multifunction peripheral including a printer function; however, the image forming apparatus 2 is not so limited.

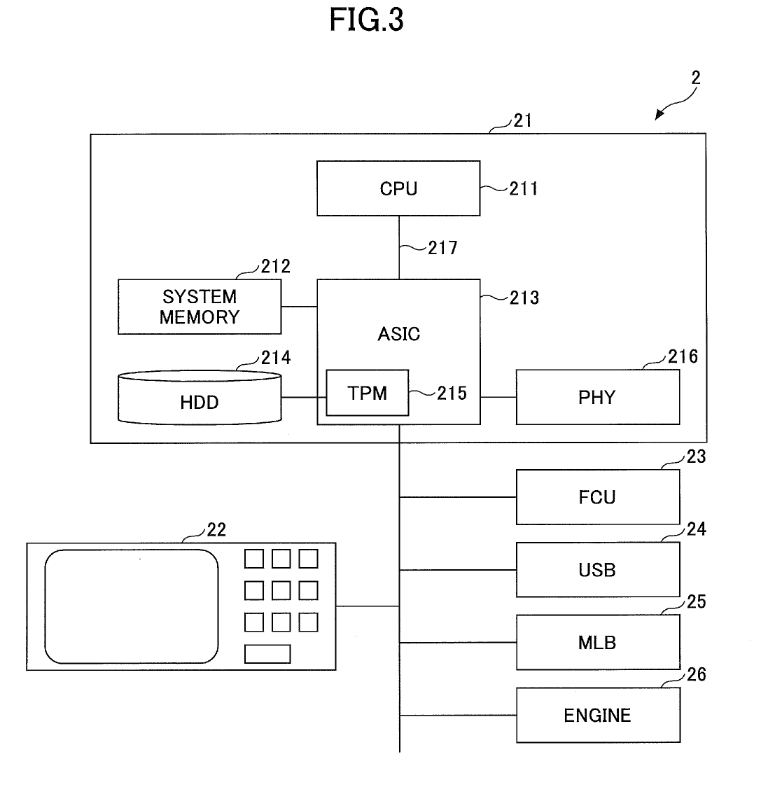

FIG. 3 illustrates an example of a hardware configuration of the image forming apparatus 2. In the following, a description is given of a case where the image forming apparatus 2 is a multifunction peripheral.

The image forming apparatus 2 illustrated in FIG. 3 includes a controller 21, an operation panel 22, a Fax Control Unit (FCU) 23, a Universal Serial Bus (USB) device 24, a media local bus (MLB) 25, and an engine 26. Furthermore, although not illustrated, the image forming apparatus 2 includes a sheet conveying device, an imaging device, and a printing device.

The controller 21 includes a CPU 211, a system memory 212, an Application Specific Integrated Circuit (ASIC) 213, and a HDD 214. Furthermore, the controller 21 includes a Trusted Platform Module

(TPM) chip 215, a Physical Layer (PHY) chip 216, and a data transfer bus 217.

The CPU 211, the system memory 212, the HDD 214, and the PHY chip 216 are coupled to the ASIC 213 by the data transfer bus 217. In the example of FIG. 3, the TPM chip 215 is installed in the ASIC 213; however, the TPM chip 215 may be an independent large scale integrated circuit (LSI).

The CPU 211 controls the entire image forming apparatus 2. Furthermore, as the CPU 211 executes various kinds of software, various functions of the image forming apparatus 2 (for example, a printer function and a scanner function, etc.) are realized.

The system memory 212 is, for example, a RAM, an SRAM, or a DRAM; however, the system memory 212 is not so limited.

The HDD 214 stores an OS, various kinds of software for realizing the functions of the image forming apparatus 2, and various kinds of data (for example, image data of a prescription image) used by the image forming apparatus 2. The OS and software stored in the HDD 214 are expanded in the system memory 212, and executed by the CPU 211.

The TPM chip 215 encrypts the data stored in the HDD 214 by using an encryption key. The TPM chip 215 holds the encryption key in a built-in memory, and is therefore resistant to attacks from outside. By using the TPM chip 215, it is possible to reduce the risk of information leakage due to data theft from the HDD 214 and analysis of the data.

The PHY chip 216 converts the logical signals output from the ASIC 213 into electric signals, and outputs the electric signals. Furthermore, the PHY chip 216 converts electric signals input from an external device into logical signals, and inputs the logical signals to the ASIC 213.

The operation panel 22 is an input output device of the image forming apparatus 2. The operation panel 22 includes push buttons and a touch panel as an input device. Furthermore, the operation panel 22 includes a display device such as a liquid crystal display and a speaker as an output device. The operation panel 22 is coupled to the ASIC 213 by the data transfer bus 217.

The FCU 23 controls the fax function. Specifically, the FCU 23 controls the fax transmission and reception by using Public Switched Telephone Network (PSTN) and Integrated Services Digital Network (ISDN). Furthermore, the FCU 23 controls the registering and the extracting of various kinds of fax data managed by a backup memory, fax reading, and fax reception and printing, etc.

The USB device 24 is a peripheral device that is coupled by using USB. The USB device 24 is, for example, a two-dimensional code reader; however, the USB device 24 is not so limited.

The engine 26 includes a printer engine for realizing a printer function and a scan engine for realizing a scanner function.

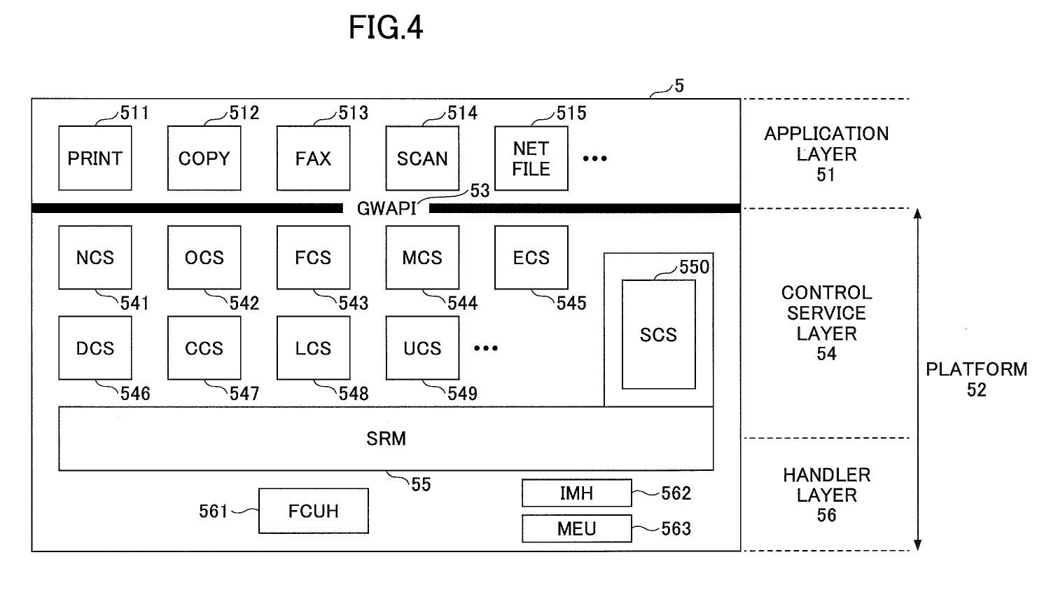

FIG. 4 illustrates an example of a software group 5 included in the image forming apparatus 2. Each software item included in the software group 5 is stored in the HDD 214, loaded in the system memory 212, and executed by the CPU 211. Accordingly, various functions of the image forming apparatus 2 are realized.

The software items included in the software group 5 are executed in parallel as processes, in an OS such as UNIX (registered trademark). The software group 5 includes software included in an application layer 51 and software included in a platform 52.

The application layer 51 includes software for performing processes unique to various services relevant to image forming. The application layer 51 includes a print application (PRINT) 511, a copy application (COPY) 512, and a fax application (FAX) 513. Furthermore, the application layer 51 includes a scan application (SCAN) 514 and a net file application (NET FILE) 515.

The platform 52 includes a Gateway Application Programing Interface (GWAPI) 53, a control service layer 54, a System Resource Manager (SRM) 55, and a handler layer 56.

The GWAPI 53 enables the platform to receive a process request from the application layer 51, by a function defined in advance.

The control service layer 54 includes one or more service modules, and analyzes a process request from the application layer 51, and generates a request to acquire the ASIC 213. The control service layer 54 includes a Network Control Service (NCS) 541, an Operation Control Service (OCS) 542, a Fax Control Service (FCS) 543, and a Memory Control Service (MCS) 544.

Furthermore, the control service layer 54 includes an Engine Control Service (ECS) 545, a Delivery Control Service (DCS) 546, a Certification and charge Control Service (CCS) 547, a Log Control Service (LCS) 548, a User information Control Service (UCS) 549, and a System Control Service (SCS) 550.

The NCS 541 provides a service that can be commonly used by one or more software items (applications) requiring the network I/O. For example, the NCS 541 assigns the data received from a network to the software items. Furthermore, the NCS 541 performs mediation for sending the data from the software to the network. The OCS 542 controls the operation panel 22.

The FCS 543 provides an Application Programing Interface (API) for performing the fax transmission and reception using PSTN and ISDN, the registering and the extracting of various kinds of fax data managed by a backup memory, fax reading, and fax reception and printing, etc.

The MCS 544 performs memory control, such as securing and releasing the system memory 212 and using the HDD 214. The ECS 545 controls the engine 26. The DCS 546 controls the distribution, etc., of an accumulated document. The CCS 547 controls the authentication and charging. The LCS 548 manages and holds log information. The UCS 549 manages user information.

The SCS 550 manages the ASIC 213 and applications, displays a light emitting diode (LED), controls an interruption application, etc.

The SRM 55 is a lower layer of the service module such as the NCS 541, and adjusts the acquisition request from the control service layer 54, according to the usage status of resources. Furthermore, the SRM 55 controls the ASIC 213 together with the SCS 550.

When an upper layer such as the NCS 541 generates a request to acquire the ASIC 213 according to a process request from the application layer 51, the SRM 55 determines whether the ASIC 213 for which the acquisition request has been made, can be used. When the ASIC 213 can be used, the SRM 55 reports this to the upper layer. Furthermore, the SRM 55 performs scheduling for using the ASIC 213, with respect to the acquisition request from the upper layer, and executes a request content (for example, securing a memory, generating a file, imaging, and paper conveying, etc.).

The handler layer 56 manages the ASIC 213 according to an acquisition request from the SRM 55. The handler layer 56 includes a Fax Control Unit Handler (FCUH) 561, an Image Memory Handler (IMH) 562, and a Media Edit Utility (MEU) 563.

The FCUH 561 manages the FCU 23.

The IMH 562 assigns the system memory 212 to a process, and manages the assigned system memory 212.

The MEU 563 implements control relevant to image conversion.

As an example of operations of the image forming apparatus 2, a description is given of a process of reading images. In the image forming apparatus 2, the print application (PRINT) 511, the copy application (COPY) 512, and the scan application (SCAN) 514 execute the image reading process.

When the above applications generate a process request for a reading process, the process request is input to the controller 21 via the platform 52. The controller 21 controls the imaging device according to the input process request, and executes the reading of an image.

The image data of the read image is stored in the system memory 212, encrypted by the TPM chip 215 according to settings of the applications that had generated the process request and device settings, and stored in the HDD 214.

### <Description of Prescription Image—First Embodiment>

Here, a detailed description is given of a prescription image printed by the image forming apparatus 2. The prescription image includes a first image and a second image.

The first image is an image including first prescription information. The first image may include information (for example, the address and contact number of the medical institution) other than the first prescription information. The image data of the first image is generated by the medical institution terminal 1, based on the prescription information input by a staff of the medical institution.

The first prescription information is information including all of or part of the prescription information that has been input by the staff of the medical institution. The first prescription information includes the items of, for example, the name of the medial institution that has issued the prescription; the insured number, the name, and the birthdate of the patient; and the name and the quantity of the medicine to be prescribed. The items included in the first prescription information may be set in advance, or may be selected by the staff of the medical institution.

The first prescription information is visible information. Here, visible information means information that can be acquired by a patient by a general method of acquiring information. In other words, the first image is an image in which the first prescription information is embedded in a format that can be acquired by a general method for acquiring information. The general method for acquiring information includes reading a two-dimensional code by visual contact or by using an existing two-dimensional code reader. The first prescription information is visible to the patient, and may therefore be falsified by a malicious patient.

In the present embodiment, the first image includes character strings indicating the first prescription information. Therefore, by reading the character strings included in the first image, the patient can acquire the first prescription information included in the first image.

The second image is an image including second prescription information. The second prescription information is information including all of or part of the prescription information that has been input by the staff of the medical institution. The second prescription information includes the items of, for example, the name of the medial institution that has issued the prescription; the insured number, the name, and the birthdate of the patient; and the name and the quantity of the medicine to be prescribed. The items included in the second prescription information may be set in advance, or may be selected by the staff of the medical institution, by using an input device included in the image forming apparatus 2 or an external device.

The second image may include information (for example, the address and contact number of the medical institution) other than the second prescription information. The image data of the second image is generated by the medical institution terminal 1, based on the prescription information input by a staff of the medical institution.

The second prescription information is invisible information. Here, invisible information means information that cannot be acquired by a patient by a general method of acquiring information. In other words, the second image is an image in which the second prescription information is embedded in a format that cannot be acquired by a general method for acquiring information. The second prescription information is invisible to the patient, and is therefore very difficult to be falsified by a malicious patient.

The second image is, for example, a dot pattern. The dot pattern may be printed on the entire prescription, or may be printed in a partial area of the prescription. The dot pattern is formed by a plurality of dots. Each dot forming the dot pattern may be in any shape, any size, and any color. Furthermore, the shape, size, and color of the dots may be the same or may be different.

Note that the second image is preferably invisible or difficult to see by the patient. This is because, if the second image is visible, the second image may cause anxiety to the patient. By making the second image invisible or difficult to see by the patient, it is possible to prevent the second image from causing unnecessary anxiety to the patient.

When the second image is a dot pattern, the dots are preferably difficult to see, in order to make the second image difficult to see. Specifically, the diameter of each dot is preferably less than or equal to 1 mm. Furthermore, the color of each dot is preferably yellow, which is visually inconspicuous.

Note that the second image is not limited to a dot pattern. For example, the second image may be a pattern of brightness, hue, intensity, or a combination of these, superimposed on the first image.

Furthermore, the items included in the first prescription information and the items included in the second prescription information may be partially the same. Therefore, the items included in the first prescription information and the items included in the second prescription information may all be the same may be partially different. The items that are overlapping in the first prescription information and the second prescription information become the prescription information that is assured by the prescription management system 10.

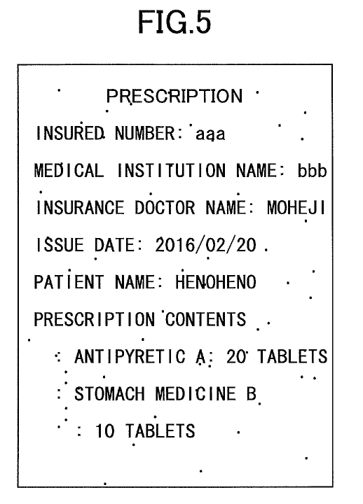

FIG. 5 illustrates an example of a prescription image according to the present embodiment. In the example of FIG. 5, the first image includes character strings such as “insured number: aaa”, “medical institution name: bbb”, and “prescription contents: antipyretic A: 20 tablets: stomach medicine: 10 tablets”. The first image includes the first prescription information indicated by these character strings. Furthermore, in the example of FIG. 5, the second image is a dot pattern printed on the entire prescription. The second image includes second prescription information corresponding to this dot pattern.

### <Configuration of Image Processing Apparatus 3—First Embodiment>

The image processing apparatus 3 reads a prescription image from the prescription, and displays the first prescription information and the second prescription information included in the read prescription image, on a display device. The image processing apparatus 3 is a scanner or a multifunction peripheral including a scanner function; however, the image processing apparatus 3 is not so limited. The hardware configuration of the image processing apparatus 3 is the same as that of the image forming apparatus 2, and therefore descriptions of the hardware configuration are omitted.

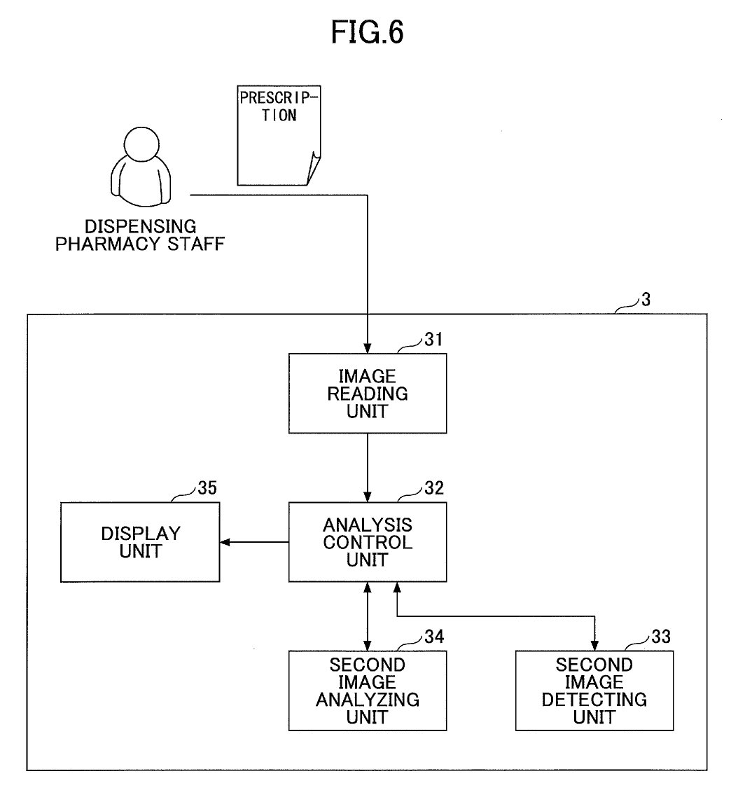

FIG. 6 illustrates an example of a functional configuration of the image processing apparatus 3 according to the present embodiment. The image processing apparatus 3 illustrated in FIG. 6 includes an image reading unit 31, an analysis control unit 32, a second image detecting unit 33, a second image analyzing unit 34, and a display unit 35. These functional units are realized as the CPU executes the corresponding software.

The image reading unit 31 reads a prescription image from a prescription. The image reading unit 31 is realized by the scanner function of the multifunction peripheral. The image reading unit 31 generates image data of the read prescription image, and transfers the generated image data to the analysis control unit 32.

The analysis control unit 32 controls the analysis of the image data of the prescription image. Details of the analysis control by the analysis control unit 32 are described below.

The second image detecting unit 33 receives image data of the prescription image from the analysis control unit 32, and detects the second image included in the prescription image, based on the received image data. That is, the second image detecting unit 33 determines whether the second image is included in the prescription image. The second image detecting unit 33 transfers the detection result to the analysis control unit 32. The method of detecting the second image may be determined according to the method of generating the second image.

For example, when the second image is a dot pattern, a second image including detection-use dots may be generated. The detection-use dots are dots indicating the presence of the second image. As the detection-use dots, dots printed at predetermined positions in the prescription image, dots having a predetermined shape and color, and a plurality of dot groups arranged in a predetermined pattern, may be used. When the second image includes the detection-use dots, the second image detecting unit 33 can detect the second image by detecting the detection-use dots included in the prescription image.

The second image analyzing unit 34 receives image data of the prescription image from the analysis control unit 32, analyzes the received image data, and acquires second prescription information from the second image. The second image analyzing unit 34 transfers the analysis result, that is, the second prescription information obtained by the analysis, to the analysis control unit 32. The method of analyzing the second image may be determined according to the method of generating the second image.

The display unit 35 displays the first prescription information and the second prescription information included in the prescription image, in a format (comparable format) by which the first prescription information and the second prescription information can be compared by a user of the image processing apparatus 3 and the dispensing pharmacy terminal 4 (for example, the staff of a dispensing pharmacy), on a display device. The display device may be the display device of the image processing apparatus 3 or the display device of the dispensing pharmacy terminal 4, or may be both of these display devices. Furthermore, displaying on a display device means to output the data of the first prescription information and the second prescription information upon processing the data such that the display device can display the data.

### <Configuration of Dispensing Pharmacy Terminal 4—First Embodiment>

The dispensing pharmacy terminal 4 is a terminal installed in the dispensing pharmacy, and is coupled to the image processing apparatus 3. In the example of FIG. 1, one dispensing pharmacy terminal 4 is coupled to the image processing apparatus 3; however, a plurality of the dispensing pharmacy terminals 4 may be coupled to the image processing apparatus 3.

Furthermore, some of the functional units of the image processing apparatus 3 may be realized as the CPU of the dispensing pharmacy terminal 4 executes the corresponding software. In this case, the image processing apparatus 3 is formed of a scanner or a multifunction peripheral, and the dispensing pharmacy terminal 4. The dispensing pharmacy terminal 4 may realize at least one function among the functional units (the analysis control unit 32, the second image detecting unit 33, the second image analyzing unit 34, and the display unit 35) other than the image reading unit 31. Note that the hardware configuration of the dispensing pharmacy terminal 4 is the same as that of the medical institution terminal 1, and therefore descriptions of the hardware configuration are omitted.

### <Operations of Image Processing Apparatus 3—First Embodiment>

First, an overview of the process and procedures at the prescription management system 10 according to the present embodiment is described. First, when the staff of the medical institution inputs prescription information in the medical institution terminal 1, the image forming apparatus 2 prints the prescription image on a prescription sheet, and creates a prescription. The prescription created in this way is issued to the patient.

Next, the patient who has received the prescription goes to the dispensing pharmacy, and passes the prescription to the staff of the dispensing pharmacy. The staff of the dispensing pharmacy who has received the prescription reads the prescription with the image processing apparatus 3, and confirms whether the prescription has been falsified. When the prescription has not been falsified, the staff of the dispensing pharmacy prescribes medicine to the patient by following the prescription.

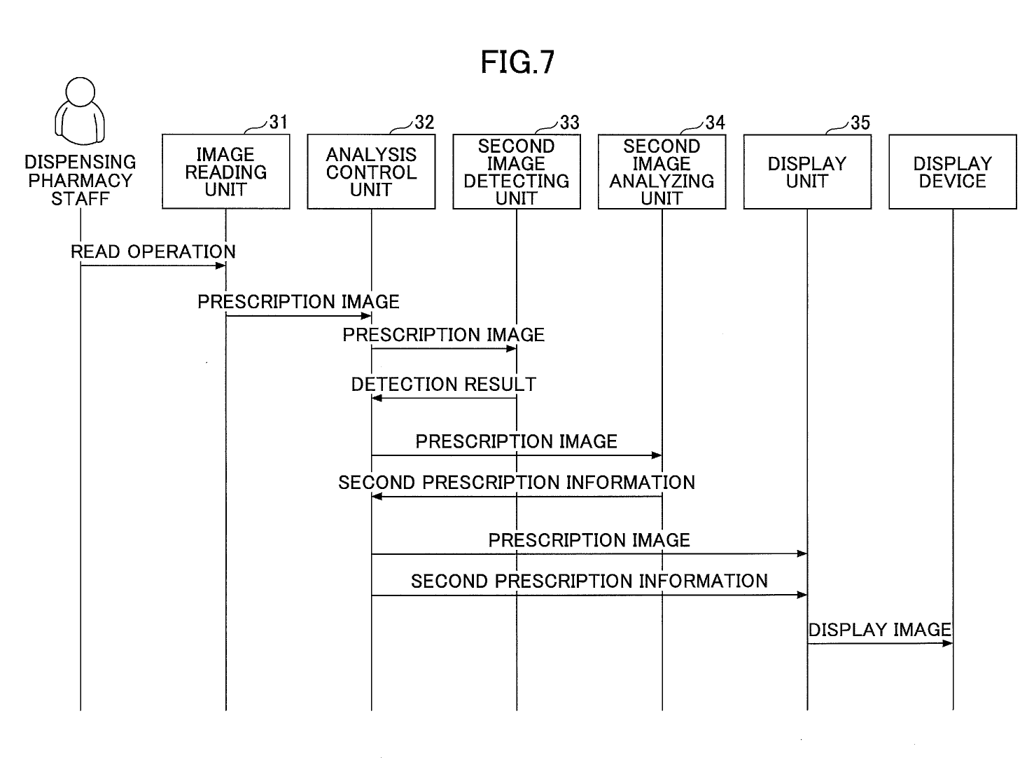

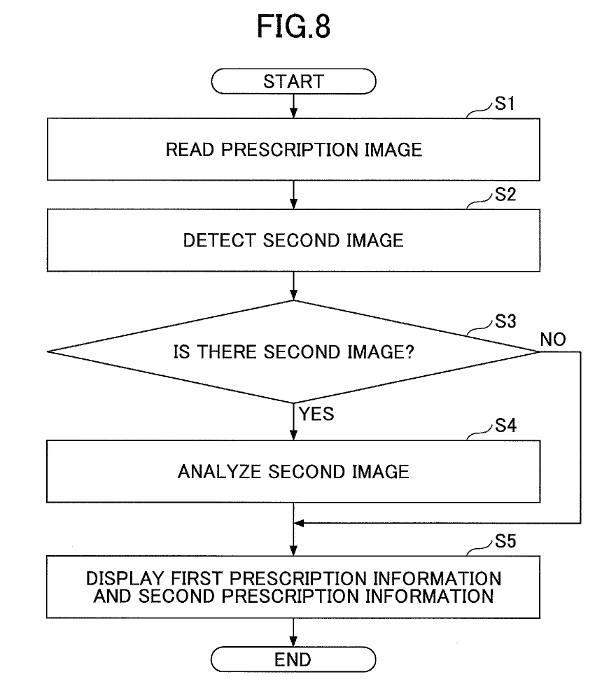

In the following, a description is given of operations by the image processing apparatus 3, when confirming whether the prescription has been falsified. FIG. 7 is a sequence diagram of an example of operations by the image processing apparatus 3. FIG. 8 is a flowchart of an example of operations by the image processing apparatus 3.

First, the staff of the dispensing pharmacy sets the prescription received from the patient, at a predetermined position of the image processing apparatus 3, and inputs a read operation by an input device such as the operation panel 22. The read operation may be input from an input device included in the dispensing pharmacy terminal 4.

When the read operation is input to the image processing apparatus 3, the image reading unit 31 reads the prescription image from the prescription, and generates image data of the prescription image (step S1). The image reading unit 31 transfers the generated image data of the prescription image, to the analysis control unit 32.

Next, the analysis control unit 32 transfers the received image data of the prescription image, to the second image detecting unit 33. The second image detecting unit 33 detects the second image included in the prescription image, based on the received image data of the prescription image (step S2). The method of detecting the second image is as described above. The second image detecting unit 33 transfers the obtained detection result to the analysis control unit 32.

When the analysis control unit 32 receives a detection result that the second image cannot be detected, that is, when the second image is not included in the prescription image (NO in step S3), the process proceeds to step S5 described below.

Cases where the second image is not included in the prescription image may include a case where the medical institution terminal 1 does not include a function of generating the image data of the second image, a case where the prescription is a fake prescription created by a malicious patient, and a case where a sheet other than a prescription has been erroneously set at the image processing apparatus 3.

On the other hand, when the analysis control unit 32 receives a detection result that the second image is detected, that is, the second image is included in the prescription image (YES in step S3), the analysis control unit 32 transfers the image data of the prescription image to the second image analyzing unit 34. At this time, the analysis control unit 32 may extract the image data of the second image from the image data of the prescription image, and transfer the extracted image data of the second image to the second image analyzing unit 34.

Next, the second image analyzing unit 34 analyzes the image data of the second image included in the prescription image, and acquires second prescription information included in the second image (step S4). The second image analyzing unit 34 transfers the acquired second prescription information to the analysis control unit 32.

The analysis control unit 32 transfers the received second prescription information and the image data of the prescription image, to the display unit 35. In the example of FIG. 7, the analysis control unit 32 transfers the second prescription information and the image data of the prescription image to the display unit 35 at the same timing. However, the analysis control unit 32 may transfer the image data of the prescription image to the display unit 35 beforehand. Furthermore, the image data of the prescription image may be transferred to the display unit 35 by the image reading unit 31.

Subsequently, the display unit 35 displays the prescription image and the second prescription information on the display device, in a comparable format (step S5). However, when the second image is not included in the prescription image, the second prescription information is not displayed.

In the present embodiment, the first image includes character strings indicating the first prescription information. Therefore, displaying the prescription image including the first image corresponds to displaying the first prescription information. Therefore, by displaying the prescription image and the second prescription information in a comparable format, the staff of the dispensing pharmacy can compare the first prescription information and the second prescription information on the screen of the display device.

As described above, the second prescription information is invisible information, and is thus very difficult to falsify. That is, there is a high possibility that the second prescription information is not falsified. Therefore, when the first prescription information and the second prescription information have different parts (items of different contents), the different part is considered to be a part where the first prescription information has been falsified.

As a result, the staff of the dispensing pharmacy can compare the first prescription information with the second prescription information to find a falsification made to the first prescription information, and prevent someone from acquiring an illegal medicine by falsifying the first prescription information. Furthermore, the staff can recognize whether a falsification has been made to the first prescription information, and therefore the first prescription information can be assured. Furthermore, even when the medical institution terminal 1 and the dispensing pharmacy terminal 4 are not coupled to a network, it is possible to find the falsification made to the prescription.

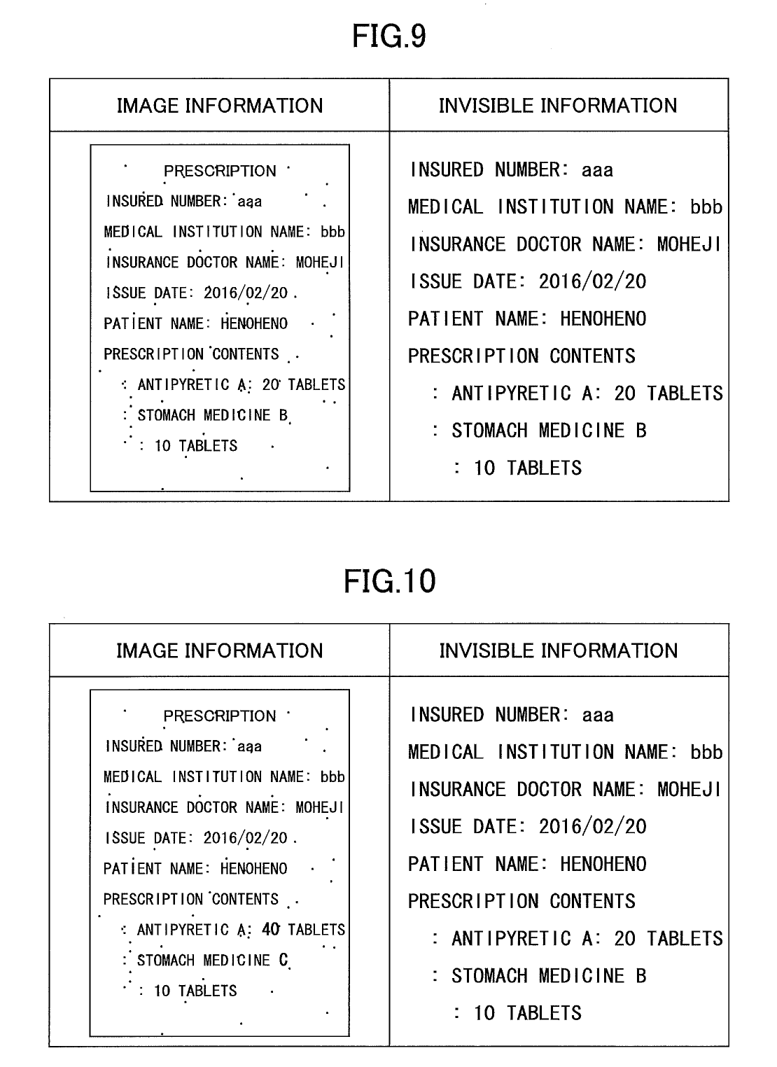

FIGS. 9 and 10 illustrate examples of the first prescription information and the second prescription information displayed on a display device. FIG. 9 illustrates a case where the first image (first prescription information) is not falsified, and FIG. 10 illustrates a case where the first image (first prescription information) has been falsified.

In the examples of FIGS. 9 and 10, the prescription image (first prescription information) and the second prescription information are displayed side by side on the same screen, so as to be easily comparable. In FIGS. 9 and 10, the left column (image information) is the prescription image, and the right column (invisible information) is the second prescription information.

In the example of FIG. 9, the first image (first prescription information) is not falsified, and therefore the first prescription information and the second prescription information are completely the same.

On the other hand, in the example of FIG. 10, the first image (first prescription information) has been falsified, and therefore the first prescription information and the second prescription information have different parts. Specifically, according to the first prescription information, 40 tablets of an antipyretic A are prescribed; however, according to the second prescription information, 20 tablets of an antipyretic A are prescribed. This indicates that the quantity of the antipyretic A in the first prescription information has been falsified. Furthermore, according to the first prescription information, a stomach medicine C is prescribed; however, according to the second prescription information, a stomach medicine B is prescribed. This indicates that the type of the stomach medicine has been falsified in the first prescription information.

As described above, by displaying the first prescription information and the second prescription information in a comparable format, the staff of the dispensing pharmacy can easily find a falsification in the prescription.

Note that in the examples of FIGS. 9 and 10, the items included in the first prescription information and the items included in the second prescription information are the all the same, and therefore all of the items are targets of assurance. For example, by comparing the insured number in the first prescription information with the insured number in the second prescription information, it is possible to find a falsification in the insured number, and assure the insured number.

However, as described above, the items included in the first prescription information and the items included in the second prescription information may be partially different. In this case, the overlapping items in the first prescription information and the second prescription information are targets of assurance. For example, in the examples of FIGS. 9 and 10, when the second prescription information does not include an insured number, a medical institution name, a health insurance doctor name, an issue date, or a patient name, the target of assurance is the prescription contents (the type and quantity of medicine). The target of assurance may be any item; however, the target of assurance is preferably an item that is highly likely to be falsified (for example, the type and quantity of medicine).

### Second Embodiment

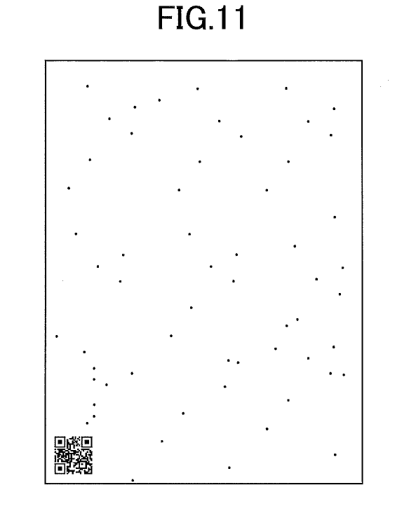

A description is given of a second embodiment by referring to FIGS. 11 through 16. In the present embodiment, a description is given of a case where the first image is a two-dimensional code including the first prescription information. In the following, the first image is simply referred to as a two-dimensional code.

In the present embodiment, the medical institution terminal 1 generates image data of a prescription image including a two-dimensional code including first prescription information and a second image including second prescription information. Furthermore, the image forming apparatus 2 prints the prescription image including the two-dimensional code and the second image on a prescription sheet, and creates a prescription. The two-dimensional code is, for example, a QR code (registered trademark); however, the two-dimensional code is not so limited.

FIG. 11 illustrates an example of a prescription image according to the present embodiment. In the example of FIG. 11, a two-dimensional code is included at the bottom left of the prescription image. Furthermore, in the example of FIG. 11, the second image is a dot pattern printed on the entire prescription. In the present embodiment, the patient can acquire the first prescription information by reading the two-dimensional code by using a two-dimensional code reader. That is, the first prescription information included in the two-dimensional code is visible information.

### <Configuration of Image Processing Apparatus 3—Second Embodiment>

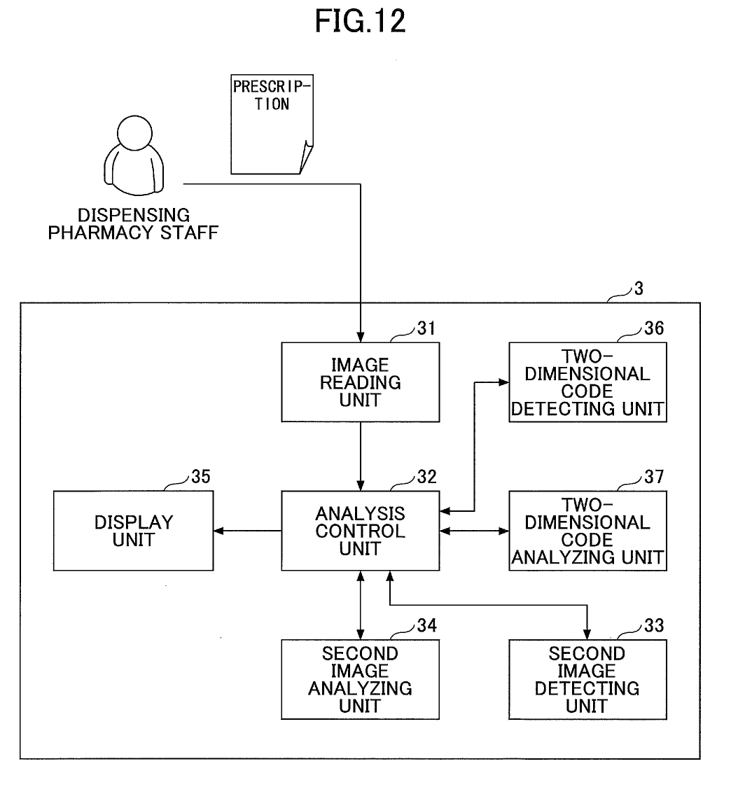

FIG. 12 illustrates an example of a functional configuration of the image processing apparatus 3 according to the present embodiment. The image processing apparatus 3 of FIG. 12 includes a two-dimensional code detecting unit 36 and a two-dimensional code analyzing unit 37. The other configurations are the same as those of the first embodiment.

The two-dimensional code detecting unit 36 receives image data of the prescription image from the analysis control unit 32, and detects the two-dimensional code included in the prescription image, based on the received image data. That is, the two-dimensional code detecting unit 36 determines whether a two-dimensional code is included in the prescription image. The two-dimensional code detecting unit 36 transfers the detection result to the analysis control unit 32. As a method of detecting the two-dimensional code, an existing method may be used according to the type of the two-dimensional code.

The two-dimensional code analyzing unit 37 receives the image data of the prescription image from the analysis control unit 32, analyzes the received image data, and acquires the first prescription information from the two-dimensional code included in the prescription image. The two-dimensional code analyzing unit 37 transfers the analysis result, that is, the first prescription information obtained by the analysis, to the analysis control unit 32. As a method of analyzing the two-dimensional code, an existing method may be used according to the type of the two-dimensional code.

### <Operations of Image Processing Apparatus 3—Second Embodiment>

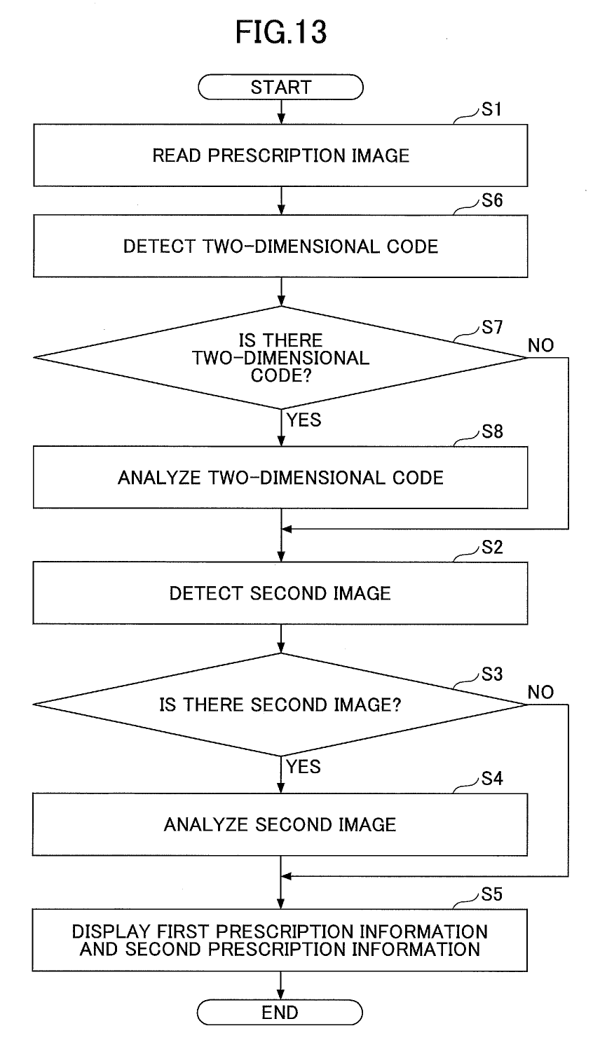

Next, a description is given of operations by the image processing apparatus 3 according to the present embodiment. FIG. 13 is a flowchart of an example of operations by the image processing apparatus 3. Steps S1 through S5 of FIG. 13 are the same as those of the first embodiment.

First, the staff of the dispensing pharmacy sets the prescription at a predetermined position of the image processing apparatus 3, and inputs a read operation by an input device such as the operation panel 22. The read operation may be input from an input device included in the dispensing pharmacy terminal 4.

When the read operation is input to the image processing apparatus 3, the image reading unit 31 reads the prescription image from the prescription, and generates image data of the prescription image (step S1). The image reading unit 31 transfers the generated image data of the prescription image, to the analysis control unit 32.

Next, the analysis control unit 32 transfers the received image data of the prescription image, to the two-dimensional code detecting unit 36. The two-dimensional code detecting unit 36 detects the two-dimensional code included in the prescription image, based on the received image data of the prescription image (step S6). The method of detecting the two-dimensional code is as described above. The two-dimensional code detecting unit 36 transfers the obtained detection result to the analysis control unit 32.

When the analysis control unit 32 receives a detection result that the two-dimensional code cannot be detected, that is, when the two-dimensional code is not included in the prescription image (NO instep S7), the process proceeds to step S2 described below.

Cases where the two-dimensional code is not included in the prescription image may include a case where the medical institution terminal 1 does not include a function of generating the image data of the two-dimensional code, and a case where a sheet other than a prescription has been erroneously set at the image processing apparatus 3.

On the other hand, when the analysis control unit 32 receives a detection result that the two-dimensional code is detected, that is, the two-dimensional code is included in the prescription image (YES in step S7), the analysis control unit 32 transfers the image data of the prescription image to the two-dimensional code analyzing unit 37. At this time, the analysis control unit 32 may extract the image data of the two-dimensional code from the image data of the prescription image, and transfer the extracted image data of the two-dimensional code to the two-dimensional code analyzing unit 37.

Next, the two-dimensional code analyzing unit 37 analyzes the image data of the two-dimensional code included in the prescription image, and acquires first prescription information included in the two-dimensional code (step S8). The two-dimensional code analyzing unit 37 transfers the acquired first prescription information to the analysis control unit 32.

Subsequently, the process proceeds to step S2. The processes from step S2 and onward are the same as those of the first embodiment. That is, the second image detecting unit 33 detects the second image included in the prescription image (step S2). When the second image is detected (YES in step S3), the second image analyzing unit 34 analyzes the second image and acquires the second prescription information (step S4). Then, the display unit 35 displays the first prescription information and the second prescription information on the display device, in a comparable format (step S5). Note that when the two-dimensional code is not detected (NO in step S7), the first prescription information is not displayed. Furthermore, when the second image is not detected (NO in step S3), the second prescription information is not displayed.

According to the present embodiment, the staff of the dispensing pharmacy can compare the first prescription information with the second prescription information on a screen of a display device to find a falsification made to the first prescription information, and prevent someone from acquiring an illegal medicine by falsifying the first prescription information. Furthermore, the staff can recognize whether a falsification has been made to the first prescription information, and therefore the first prescription information can be assured. Furthermore, even when the medical institution terminal 1 and the dispensing pharmacy terminal 4 are not coupled to a network, it is possible to find the falsification made to the prescription.

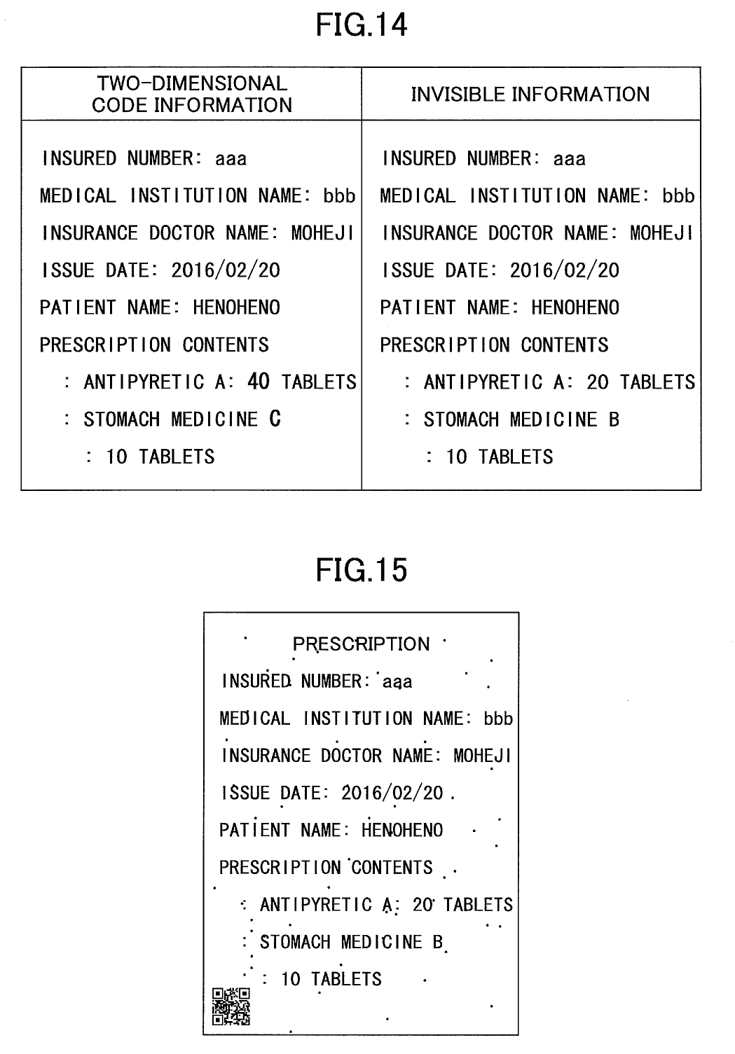

FIG. 14 illustrates an example of the first prescription information and the second prescription information displayed on a display device. FIG. 14 illustrates an example of a case where the two-dimensional code (first prescription information) has been falsified. In the example of FIG. 14, the first prescription information and the second prescription information are displayed side by side on the same screen, so as to be easily comparable. In FIG. 14, the left column (two-dimensional code information) is the first prescription information, and the right column (invisible information) is the second prescription information.

As described above, by displaying the first prescription information and the second prescription information in a comparable format, the staff of the dispensing pharmacy can easily find a falsification in the prescription.

Note that order of performing the processes of analyzing the two-dimensional code (steps S6 through S8) and the steps of analyzing the second image (steps S2 through S4) may be reversed.

Furthermore, the prescription image may include both the character strings indicating the first prescription information and the two-dimensional code including the first prescription information, as the first image. FIG. 15 illustrates an example of such a prescription image.

The prescription image of FIG. 15 includes, as the first image, character strings and a two-dimensional code. The character strings include “insured number: aaa”, “medical institution name: bbb”, and “prescription contents: antipyretic A: 20 tablets: stomach medicine B: 10 tablets”.

Furthermore, in the prescription image of FIG. 15 includes a dot pattern printed on the entire prescription, as the second image.

When the image processing apparatus 3 reads a prescription image as illustrated in FIG. 15, the first prescription information may be displayed by displaying the prescription image, or the first prescription information read from the two-dimensional code may be displayed. Furthermore, the image processing apparatus 3 may display both the prescription image and the first prescription information read from the two-dimensional code.

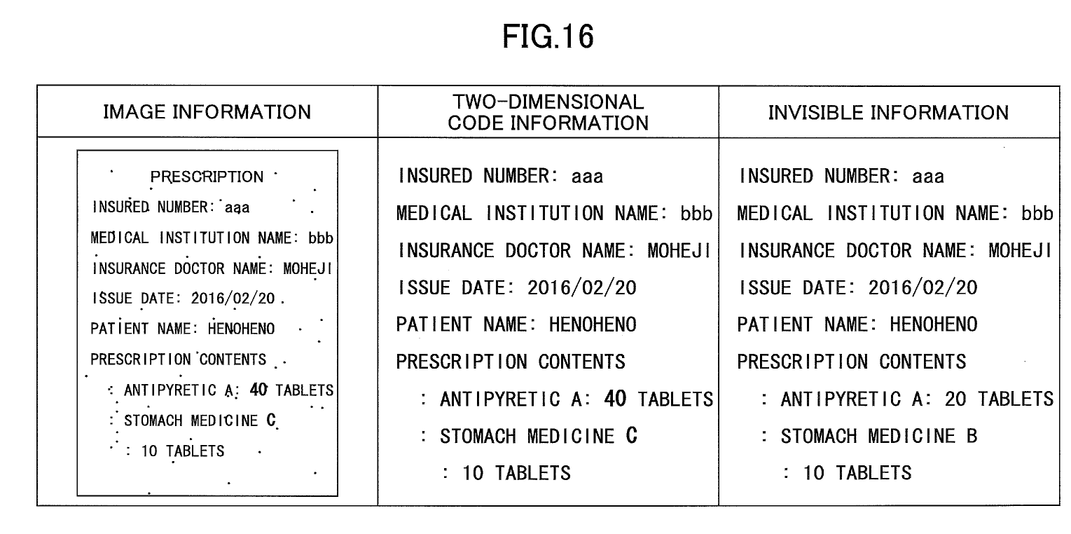

FIG. 16 illustrates an example of first prescription information and second prescription information displayed on a display device. FIG. 16 illustrates a case where the first prescription information has been falsified. In the example of FIG. 16, as the first prescription information, a prescription image and the first prescription information read from the two-dimensional code are displayed. In FIG. 16, the left column (image information) is the first prescription information (prescription image), the middle column (two-dimensional code information) is the first prescription information read from the two-dimensional code, and the right column (invisible information) is the second prescription information.

As described above, by displaying both the prescription image and the first prescription information read from the two-dimensional code, it is possible to assure the first prescription information even more reliably. Note that the first prescription information indicated by the character strings included in the prescription image and the first prescription information included in the two-dimensional code may be partially different.

### Third Embodiment

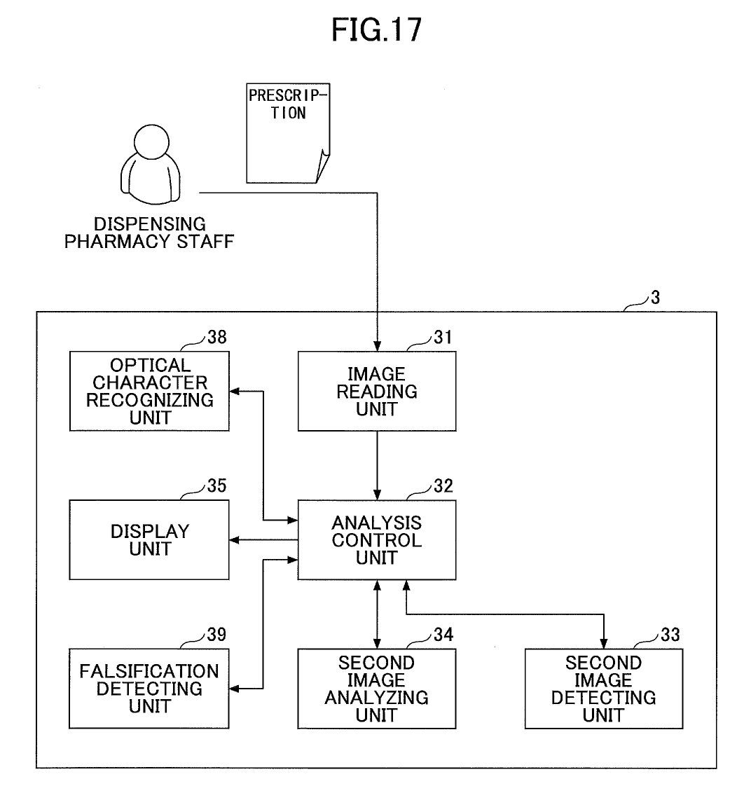

A description is given of a third embodiment by referring to FIGS. 17 through 19. In the present embodiment, a description is given of a case where the image processing apparatus 3 detects a falsification based on the first prescription information and the second prescription information acquired from the prescription image. In the following, the prescription image is assumed to include character strings indicating the first prescription information, as a first image.

### <Configuration of Image Processing Apparatus 3—Third Embodiment>

FIG. 17 illustrates an example of a functional configuration of the image processing apparatus 3 according to the present embodiment. The image processing apparatus 3 of FIG. 17 includes an optical character recognizing unit 38 and a falsification detecting unit 39. The other configurations are the same as those of the first embodiment.

The optical character recognizing unit 38 acquires first prescription information from the first image included in the prescription image, by optical character recognition. The optical character recognizing unit 38 may use any existing method as the optical character recognition method.

The falsification detecting unit 39 detects a falsification made to the first prescription information, based on the first prescription information and the second prescription information acquired from the prescription image. Specifically, the falsification detecting unit 39 compares the first prescription information with the second prescription information, and when there is an item having different contents, the falsification detecting unit 39 detects the item in which the first prescription information has been falsified. The falsification detecting unit 39 transfers the obtained detection result to the analysis control unit 32.

### <Operations of Image Processing Apparatus 3—Third Embodiment>

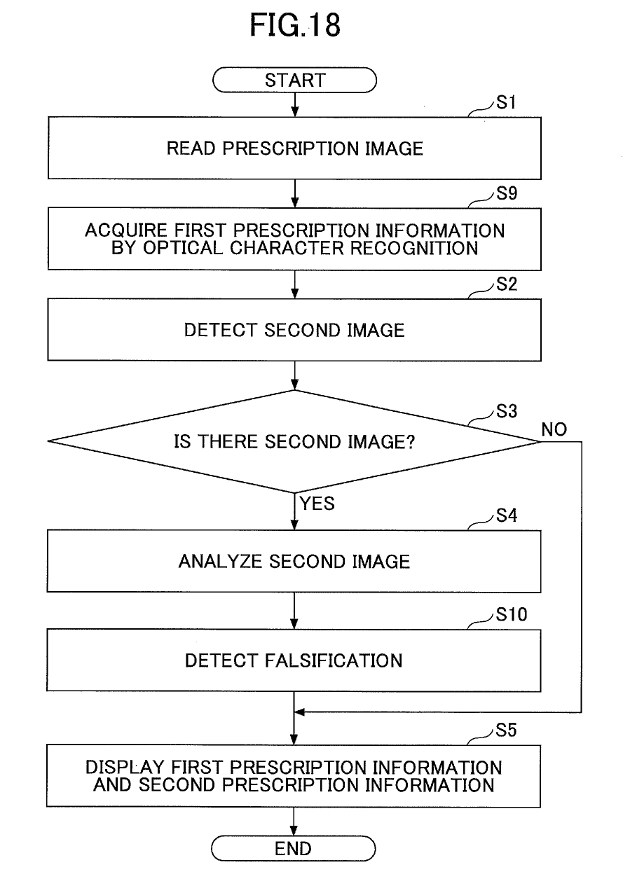

Next, a description is given of operations by the image processing apparatus 3 according to the present embodiment. FIG. 18 is a flowchart of an example of operations by the image processing apparatus 3. Steps S1 through S5 of FIG. 18 are the same as those of the first embodiment.

First, the staff of the dispensing pharmacy sets the prescription at a predetermined position of the image processing apparatus 3, and inputs a read operation by an input device such as the operation panel 22. The read operation may be input from an input device included in the dispensing pharmacy terminal 4.

When the read operation is input to the image processing apparatus 3, the image reading unit 31 reads the prescription image from the prescription, and generates image data of the prescription image (step S1). The image reading unit 31 transfers the generated image data of the prescription image, to the analysis control unit 32.

Next, the analysis control unit 32 transfers the received image data of the prescription image, to the optical character recognizing unit 38. The optical character recognizing unit 38 recognizes the contents of character strings (first image) included in the prescription image by optical character recognition, based on the received image data, and acquires the first prescription information (step S9). The optical character recognizing unit 38 transfers the acquired first prescription information to the analysis control unit 32.

Subsequently, the processes of steps S2 through S4 are executed. That is, the second image detecting unit 33 detects the second image included in the prescription image (step S2). When the second image is detected (YES in step S3), the second image analyzing unit 34 analyzes the second image and acquires the second prescription information (step S4). The second image analyzing unit 34 transfers the acquired second prescription information to the analysis control unit 32.

Next, the analysis control unit 32 transfers the first prescription information and the second prescription information to the falsification detecting unit 39. The falsification detecting unit 39 compares the first prescription information with the second prescription information, and detects whether there is a falsification in the first prescription information (step S10). The falsification detecting unit 39 transfers the detection result to the analysis control unit 32.

Then, the analysis control unit 32 transfers the detection result, the first prescription information, and the second prescription information, to the display unit 35. The display unit 35 displays the first prescription information and the second prescription information on the display device, in a comparable format (step S5). Furthermore, the display unit 35 displays the detection result of a falsification, together with the first prescription information and the second prescription information. Note that when a second image is not detected (NO in step S3), the second prescription information is not displayed.

According to the present embodiment, the staff of the dispensing pharmacy can compare the first prescription information with the second prescription information on a screen of a display device to find a falsification made to the first prescription information, and prevent someone from acquiring an illegal medicine by falsifying the first prescription information. Furthermore, the staff can recognize whether a falsification has been made to the first prescription information, and therefore the first prescription information can be assured. Furthermore, even when the medical institution terminal 1 and the dispensing pharmacy terminal 4 are not coupled to a network, it is possible to find the falsification made to the prescription. Furthermore, the falsification detecting unit 39 can automatically detect a falsification in the prescription, and therefore it is possible to prevent the falsification from being overlooked due to human error, and the first prescription information can be assured with higher precision.

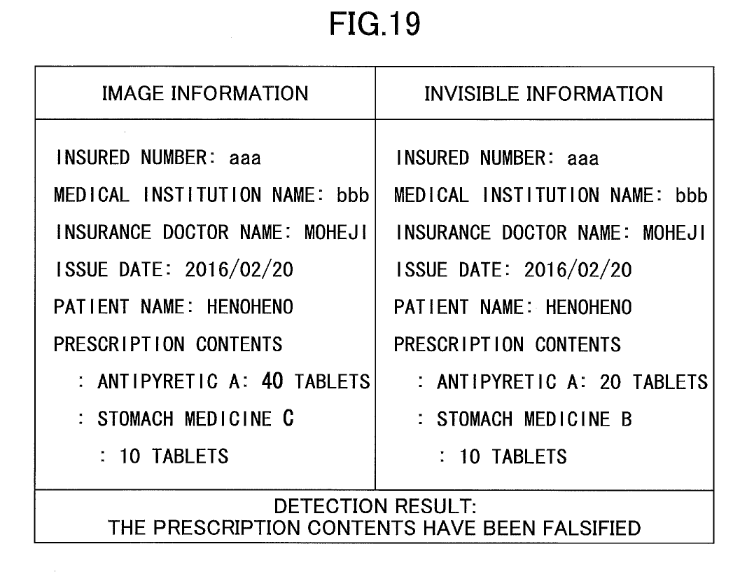

FIG. 19 illustrates an example of the first prescription information and the second prescription information displayed on a display device. FIG. 19 illustrates an example of a case where the first prescription information has been falsified. In the example of FIG. 19, the first prescription information and the second prescription information are displayed side by side on the same screen, so as to be easily comparable. Furthermore, as the first prescription information, the first prescription information read from character strings by optical character recognition, is displayed. In FIG. 19, the left column (image information) is the first prescription information, and the right column (invisible information) is the second prescription information.

Furthermore, in the example of FIG. 19, together with the first prescription information and the second prescription information, a message indicating the detection result of the falsification, that is, “the prescription contents have been falsified”, is displayed. In this way, by displaying the detection result of the falsification, the staff of the dispensing pharmacy is able to easily recognize whether a falsification has been made and the contents of the falsification.

The image processing apparatus 3 according to the present embodiment may include the two-dimensional code detecting unit 36 and the two-dimensional code analyzing unit 37, instead of the optical character recognizing unit 38. By such a configuration, the falsification detecting unit 39 can detect a falsification in the first prescription information by using the first prescription information acquired from a two-dimensional code. Furthermore, the image processing apparatus 3 may include the two-dimensional code detecting unit 36 and the two-dimensional code analyzing unit 37, together with the optical character recognizing unit 38.

According to one embodiment of the present invention, prescription information can be assured.

The image processing apparatus, the image processing method, and the prescription management system are not limited to the specific embodiments described in the detailed description, and variations and modifications, such as combinations with other elements, may be made without departing from the spirit and scope of the present invention.

What is claimed is:

1. An image processing apparatus comprising:
processing circuitry configured to
read, from a prescription, a prescription image including a first image including first prescription information that is visible and a second image including second prescription information that is invisible;
analyze the second image to acquire the second prescription information; and
display, on a display device, the first prescription information and the second prescription information in a comparable format.

2. The image processing apparatus according to claim 1, wherein
the first image includes a character string indicating the first prescription information, and
the displaying of the first prescription information and the second prescription information includes displaying the prescription image on the display device.

3. The image processing apparatus according to claim 1, wherein
the first image includes a two-dimensional code including the first prescription information, and
the displaying of the first prescription information and the second prescription information includes displaying the first prescription information included in the two-dimensional code, on the display device.

4. The image processing apparatus according to claim 3, wherein the processing circuitry further analyzes the two-dimensional code to acquire the first prescription information.

5. The image processing apparatus according to claim 2, wherein the processing circuitry further performs optical character recognition to acquire the first prescription information from the character string.

6. The image processing apparatus according to claim 1, wherein the processing circuitry further compares the first prescription information with the second prescription information to detect a falsification in the first prescription information.

7. The image processing apparatus according to claim 1, wherein the displaying of the first prescription information and the second prescription information includes displaying the first prescription information and the second prescription information side by side on a same screen of the display device.

8. An image processing method executed by a computer, the image processing method comprising:
reading, from a prescription, a prescription image including a first image including first prescription information that is visible and a second image including second prescription information that is invisible;
analyzing the second image to acquire the second prescription information; and
displaying, on a display device, the first prescription information and the second prescription information in a comparable format.

9. A prescription management system comprising:
an image forming apparatus including processing circuitry configured to create a prescription on which a prescription image is printed, the prescription image including a first image including first prescription information that is visible and a second image including second prescription information that is invisible; and
an image processing apparatus including processing circuitry configured to
read the prescription image from the prescription,
analyze the second image to acquire the second prescription information, and
display, on a display device, the first prescription information and the second prescription information in a comparable format.
